(19) United States
(12) Patent Application Publication
(10) Pub. No.: US 2001/0036588 A1
(43) Pub. Date: Nov. 1, 2001

(54) Lithographic imaging of a structure pattern onto one or more fields on a substrate

(75) Inventors: Herbert Buschbeck, Vienna (AT); Alfred Chalupka, Vienna (AT); Ernst Haugeneder, Vienna (AT); Gertraud Lammer, Vienna (AT); Hans Loschner, Vienna (AT)

Correspondence Address: THE FIRM OF KARL F ROSS, 5676 RIVERDALE AVENUE, PO BOX 900, RIVERDALE (BRONX), NY, 10471-0900, US

(73) Assignee: IMS-Ionen Mikrofabrikations Systeme GmbH

(21) Appl. No.: 09/775,924

(22) Filed: Feb. 2, 2001

Related U.S. Application Data
(63) Continuation-in-part of application No. 09/302,220, filed on Apr. 29, 1999.

(30) Foreign Application Priority Data
May 5, 1998 (AT) A742/98
Oct. 12, 1998 (AT) A1706/98

(51) Int. Cl. G03C 8/00

(52) U.S. Cl. 430/201

(57) ABSTRACT

A particle beam lithography method for imaging a structure pattern onto one or more fields on a substrate (11) by means of electrically charged particles, e.g. ions, in which a particle beam is shaped into a desired beam pattern by means of a mask positioned in the particle beam, converted into a beam pattern by apertures in the mask and projected onto the substrate to form an image of the mask apertures. According to the invention, a plurality of masks is positioned on one mask carrier, thus offering a plurality of aperture patterns which are used for producing structure patterns to be imaged onto respective areas (S) of the substrate. The patterns thus imaged, as a whole, combine together to form e.g. the total pattern of a die-field (D) of the substrate (11). By means of reference marks provided for each mask reference beamlets are produced, projected and measured with respect to their position, and from the measurement, alignment control signals are determined for aligning the position of the imaged pattern with a desired position on the substrate.

### FIELD OF THE INVENTION

This invention relates to particle beam lithography for imaging a structure pattern onto a substrate. To be more specific, this invention relates to a particle beam lithography system for imaging a structure pattern onto one or more fields on a substrate comprising

a particle-optical system with an illumination system to provide a substantially homocentric or telecentric beam of electrically charged particles,

a mask assembly arranged to position masks in the path of the particle beam, each of the masks having a membrane with apertures for producing a desired beam pattern which is imaged onto the substrate, and

a target station after the mask for supporting and positioning the substrate.

The invention equally refers to a lithographic method for imaging a structure pattern onto one or more fields on a substrate, in which a substantially homocentric or telecentric beam of electrically charged particles is generated in an illumination system and shaped into a desired beam pattern by means of a mask positioned in the path of the ion beam and having a membrane with apertures for producing the beam pattern, which in turn is projected onto the substrate supported and positioned by a target station to form an image of the mask apertures.

Moreover, the invention relates to a mask carrier for particle beam lithography.

### DESCRIPTION OF THE KNOWN PRIOR ART

A lithography system of the above-mentioned type is, for instance, the ion projection lithography apparatus as described in the U.S. Pat. No. 4,985,634 of the applicants, which is included herein by reference. A similar layout is described in the U.S. Pat. No. 5,742,062 of the applicants, which is included herein by reference as well.

In manufacturing semiconductor devices, one important step for structuring the semiconductor substrates is lithography. The substrate, for instance a silicon wafer, is coated with a thin layer of photosensitive material, called a photo-resist. By means of a lithographic imaging system, a pattern is imaged on the photo-resist, and the subsequent development step removes from the substrate either the exposed or the unexposed portion of the photo-resist. Then, the substrate is subjected to a process step such as etching, deposition, oxidation, doping or the like, the photo-resist pattern on the substrate covering those portions of the surface that shall remain unprocessed. The photo-resist is stripped, leaving the substrate with the new structure. By repeating this sequence, multiple structure layers can be introduced to form the semiconductor micro-circuits.

In projection lithography, the pattern to be imaged onto the photoresist-covered substrate is produced by using a mask or reticle having the desired pattern. For particle projection systems, stencil masks are used in which the patterns to be projected are formed as apertures of appropriate shape in a thin membrane, where the thin membrane is a few micrometers thick. Only through the mask apertures is the particle beam transmitted. Thus a beam pattern is imparted. Particles used for lithography can be any electrically charged species including electrons. Here, mainly hydrogen or helium ion lithography is discussed; it is to be understood that in the following, whenever ions are referred to, the extension to other charged particles, including e.g. electrons, is understood and easily reproducible for the person skilled in the art.

The positioning of the mask in the path of the particle beam is done by a mask assembly. Mask assemblies, as for instance those produced by Leica (Jena, Germany), are well-known in lithography and optical wafer steppers. A mask assembly can handle a number of masks, each mask being mounted on a mask carrier, which serves as a holder frame for the delicate mask.

An optical column may be used to project the ion beam pattern to an image. Several designs are disclosed e.g. in U.S. Pat. Nos. 4,985,634 and 4,967,088 of the applicants. For the appropriate positioning of the substrate and repositioning from one die field to the next, a target station is used to hold and exactly align the position of the projected image of the beam with the target field of the substrate. As also disclosed in the U.S. Pat. No. 4,967,088, the substrate alignment is controlled by measuring the position of reference beamlets at the place of the target station. From this measurement the deviation from the desired position is calculated and correction signals are derived for adjusting the alignment and/or correcting the image shape. The alignment adjustment may be performed by controlling the fine positioning of the substrate or advantageously by appropriately adjusting the optical properties of the particle-optical system, namely the illumination system and/or the optical column. This procedure is called ‘pattern lock’.

Usually one wafer is used to produce a number of identical dies, thus the same pattern is repeatedly projected onto each die field. Furthermore, since the desired structures to be imaged are often intricate, also in topological respects, it is often advantageous to divide the pattern into complementary sub-patterns, rather than using one mask for a pattern, see e.g. U. Behringer and H. Engelke, ‘Intelligent Design Splitting in the Stencil Mask Technology Used for Electron- and Ion-Beam Lithography’, Proceedings of the EIPB 1993, San Diego, Jun. 1-4, 1993. These complementary patterns are then shaped into different masks mounted onto a mask carrier and used in subsequent projecting steps to be projected onto the same die field of the substrate.

Upon masks especially high demands are posed due to the small and still shrinking feature size to date, current aim is a resolution of 100 nm, and in the near future a 70 nm resolution will be demanded—of the wafer structures and high required reliability and irradition-stability since one mask is used for the production of several thousands of wafers with several tens of dies. Reliability affects the production of the masks, since a die with but a single defect is unusable. However, due to the ever growing density of features in the wafer die layout, the probability of defects in the production is growing and is becoming a nuisance for larger die fields.

Stability against irradiation-induced damage severely restricts life-time of the mask. It is a well-known fact that the ions deposited by irradiation lead to changes in the material properties, e.g. inner stress, causing distortions of the structure features. Temperature-caused strain also affects form stability of the mask features. A possibility would be to decrease the mask area, but this would mean to decrease the die field area, quite contrary to the current trend. To achieve higher life-times of masks, different solutions, e.g. mask coatings as described in the U.S. Pat. No. 4,448,865, have been proposed. While these provisions do reduce the irradiation-induced changes, they do not improve defect reliability of the production. Therefore additional measures are required to resolve the situation.

One approach to this problem is to use a demagnifying system, e.g. by a factor of four, in which the mask pattern has dimensions four times greater than that to be formed on the substrate. This approach facilitates the production of stencil masks having enlarged structures and enhances the precision of the mask structures. On the other hand, by increasing the mask area illuminated by the ion beam and thus the size of the thin membrane, the problem arises to compensate for the mechanical and thermal instability of the increased mask area. Thus on one hand the production of masks entails high costs and waste, on the other hand the wafer yield of the mask is rather low.

### OBJECT OF THE INVENTION

It is the object of this invention to find a way to alleviate the high demands on the stencil masks, while keeping a high throughput of produced substrates and maintaining or even rising the reliability and resolution of the pattern features on the substrate.

### SUMMARY OF THE INVENTION

The object of the invention is obtained by a lithography system of the type as mentioned at the beginning wherein the mask assembly, according to the invention, comprises at least one mask carrier with a plurality of masks having different aperture patterns corresponding to structure patterns to be imaged onto respective areas of the substrate, where at least two of the structure pattern areas are different, and the mask assembly is arranged to project different aperture patterns at different times onto the substrate.

By partitioning the area to be imaged into a number of sub-areas, this solution allows for smaller exposure fields. As a consequence the overall size of the optical system can be reduced. Using the same beam current, this measure reduces the blur due to statistical Coulomb interactions and a considerable gain in resolution is obtained. If this is not required, the beam current may be increased which can be exploited to reduce the exposure times of the substrate.

In a preferred embodiment of the invention the charged particles are advantageously ions, preferably hydrogen or helium ions.

In order to use one mask set at a time for patterning a die-field, it is further advantageous if the imaged patterns of the masks, as a whole, combine together to form the total pattern of a die-field of the substrate.

In a further useful embodiment the patterns of the masks are to be imaged onto adjacent areas of the substrate.

As an alternative, the patterns of the masks can be imaged onto partially overlapping areas of the substrate. Using overlapping structures avoids the risk of defects at the seam between neighboring areas.

In order to enhance the projection accuracy during patterning, each mask is provided with reference marks producing reference beamlets, while the target station comprises an alignment system to measure the position of the reference beamlets and, from the measurement, to determine alignment control signals for aligning the position of the mask pattern image with the desired position on the substrate.

Moreover, the alignment system may be connected to the particle-optical system, the particle-optical system being adjustable with respect to its projection properties by means of the alignment control signals.

If a set of masks shall be permanently grouped on one mask carrier, advantageously the mask carrier is a mask wafer in which the masks are formed as mask fields structured with aperture patterns to be imaged onto the substrate. As a further advantage, this type of mask carrier can be produced, for instance, by means of the well-known methods of semiconductor production and patterning.

In this case, as a first possible variant, the reference marks may be structured into membrane fields (‘pattern-lock membrane fields’) of considerably smaller thickness than the mask wafer, and the pattern-lock membrane fields are separated from the mask fields by areas of the considerably thicker mask wafer material. It is, however, considered more advantageous if the mask wafer is provided with separate membrane areas, each membrane area having a membrane of substantially smaller thickness than the wafer, and the membranes are structured with the corresponding mask field aperture patterns and the reference marks. This variant ensures high mechanical stability of the separated mask fields and the respective reference marks.

As another useful possibility, especially if a large number of mask fields is to be grouped in a given carrier area, the mask wafer may be provided with one membrane area having a membrane of substantially smaller thickness than the wafer and the membrane may be structured with the different mask field aperture patterns and the respective reference marks. In this context reference marks of the masks are also arranged within said one membrane area. In order to save place, the areas surrounded by the respective reference marks may advantageously be overlapping on the mask membrane.

Another variant uses a combination of a mask carrier with mask wafer, wherein each mask on the mask carrier is formed as a separate wafer with a membrane area of substantially smaller thickness than the wafer, the membrane being structured with the corresponding aperture pattern. This allows for separate production of the pattern masks and thus lowers production costs. In this context, the mask can be individually inspected and, where needed, replaced, if the masks are mounted to the mask carrier and are individually replaceable.

Moreover it is useful if the masks are mounted to the mask carrier by adjustable mounting means. Adjusting the mounting means facilitates correcting of placement errors which may occur during the mounting of replacement masks.

Furthermore, the particle-optical system may advantageously comprises an optical column arranged between mask assembly and substrate to project the patterned beam onto the substrate to form an image of the mask apertures.

The object of the invention is met equally well by a lithographic method of the type as mentioned at the beginning wherein a plurality of aperture patterns defined by respective masks positioned on at least one mask carrier, are used for producing structure patterns to be imaged onto respective areas of the substrate, where at least two of the structure pattern areas are different, and different aperture patterns are projected at different times onto the substrate. Also in this case, preferably reference beamlets are produced by means of reference marks provided for each mask, and, from measurement of the position of the beamlets, alignment control signals are determined for aligning the position of the image of the aperture pattern with a desired position on the substrate

In this context it is useful if for each pattern, the corresponding structure pattern is projected subsequently onto every area of the substrate which is to be imaged with this pattern, positioning the substrate for each of these areas, before switching to the next pattern to be used by moving the mask carrier in a position where the mask corresponding to the next pattern is illuminated by the beam.

Moreover, the object of the invention is obtained by means of a mask carrier for particle beam lithography which comprises a plurality of masks having different aperture patterns corresponding to structure patterns to be imaged onto respective areas of the substrate, where at least two of the structure patterns are to be imaged to different areas.

Especially suitable in this context is, for use as a mask carrier in a particle beam lithography, a mask wafer which comprises a plurality of mask fields having different aperture patterns corresponding to structure patterns to be imaged onto respective areas of the substrate, and fields of reference marks are structured into membrane fields (‘pattern lock membrane fields’) of considerably smaller thickness than the mask carrier, where the pattern lock membrane fields are separated from the mask membrane fields by areas of the considerably thicker mask wafer material.

An advantageous form of this mask wafer is produced from a wafer by structuring aperture patterns onto separate membrane areas of substantially smaller thickness than the wafer, the aperture patterns forming different mask fields to be imaged onto the substrate, and structuring reference marks onto other separate membrane areas of substantially smaller thickness than the wafer.

Further features and advantages of the invention are set forth in the following description of the invention.

### BRIEF DESCRIPTION OF THE DRAWINGS

FIG. 1 is a diagrammatic section of an ion-beam lithography projector of a first embodiment of the invention;

FIG. 2 is a diagram of an arrangement of the die fields and sub-fields on a wafer as imaged in the projector of FIG. 1;

FIG. 2a is a detail of FIG. 2, showing a first die field;

FIG. 3 is an elevational view of a mask carrier with eight masks as used in the projector of

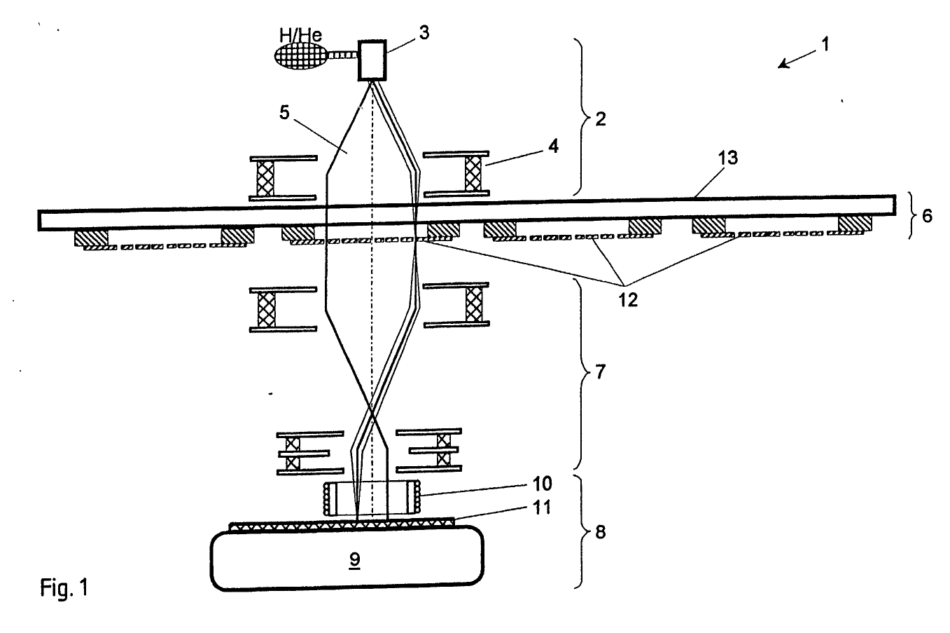

FIG. 1;

FIG. 4 is an elevational view of another mask carrier as used in the projector of FIG. 1, however, with sixteen masks;

FIG. 5 is an elevational view of a variant of the mask carrier, which is made from a single wafer;

FIG. 6 is an elevational view of a second variant of the mask carrier made from a single wafer; and

FIG. 7 is a graph displaying the blur of the image projected on the substrate as a function of the ion-beam current through the optical column for two values of the exposure field size;

FIG. 8 is a view similar to FIG. 1 of an ion-beam lithography projector of a second embodiment of the invention;

FIG. 9 is an elevational view of a mask wafer with nine mask fields for use in the projector of FIG. 8;

FIG. 10 is an elevational view of a screen with apertures for the design field and for the reference marks, as used in the projector of FIG. 8;

FIGS. 11a and 11b are views of a variant of a mask wafer as in FIG. 9, however, with four mask fields;

FIG. 12 is a view similar to FIG. 1 of an ion-beam lithography projector comprising an alignment system; and

FIG. 13 is a detail view of the alignment system of the projector system of FIG. 12.

### DETAILED DESCRIPTION OF THE INVENTION

An overview of a first preferred embodiment of the lithography system 1 according to the invention is shown in FIG. 1. The main components of the lithography system 1 are—from top to bottom—the illumination system 2, the mask assembly 6, the optical column 7, and the target station 8 with the substrate 11. In the following, only a short survey is given; further details are given in the U.S. Pat. No. 4,985,634 and 5,742,062.

The illumination system comprises an ion source 3 with an extraction system (not shown) fed by a gas supply. In the preferred embodiment, helium ions are used; it should, however, be noted that in general other ions, e.g. hydrogen ions, can be applied as well. The ion source 3 emits ions of defined energy which, by means of the condenser lens 4, are formed into a substantially homocentric or telecentric beam 5.

The ion beam 5 is projected onto a stencil mask 12 mounted in a mask assembly 6. According to the invention, the mask assembly 6 comprises a plurality of masks 12. In the lithography system 1 shown in FIG. 1, the masks 12 are grouped on at least one mask carrier 13, and serves to position the desired mask 12 into the ion beam 5. Each of the masks 12 has a membrane with apertures for producing a beam pattern, which in turn serves to form a structure pattern on the substrate.

The beam pattern produced by the mask 12 is then projected by the optical column 7 onto the substrate 11 where it forms an image of the mask apertures. In the preferred embodiments, the substrate 11 is a silicon wafer covered with a photo-resist layer. The wafer 11 is held and positioned by the target station 8 comprising a wafer stage 9 in conjunction with a correction system 10 for correcting the position and orientation of the image on the wafer.

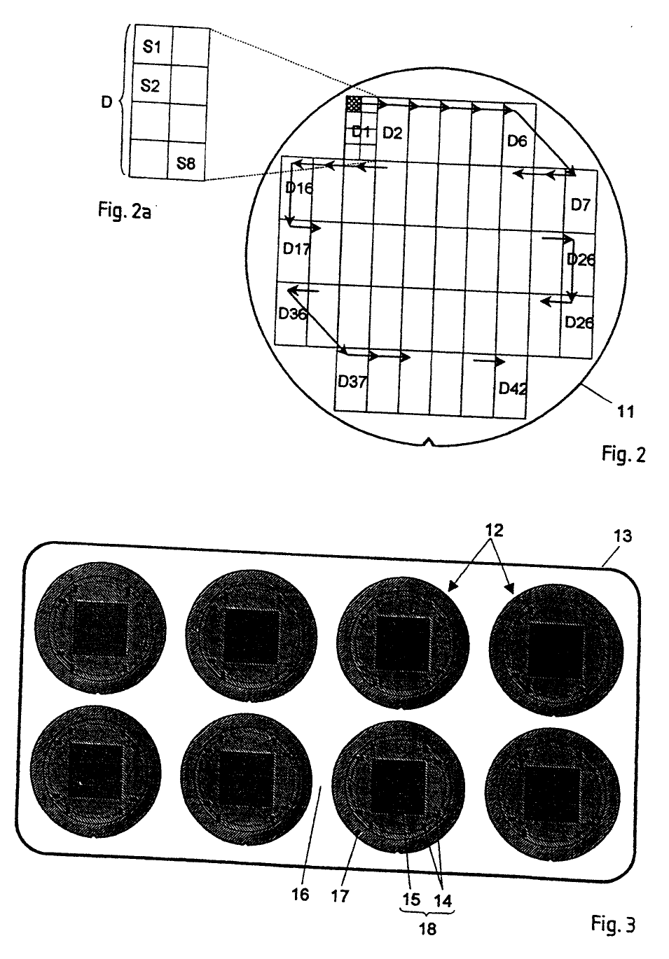

FIG. 2 schematically shows the area of a 300 mm wafer 11 which is divided into 42 rectangular die fields D of 25 mm u 50 mm, which are to receive the same structuring. The die structures are not, however, imaged onto one whole die field D at a time, as would be the case for a “full-field” system known from the state of the art. Rather, according to the invention, the die field D is split in sub-fields S whose structures are imaged individually. As shown in FIG. 2a for the first die field D1, each die field of the preferred embodiment is split into 8 quadratic sub-fields S with 12.5υ12.5 mm², arranged in a 2υ4 array, adjacent to each other and combining in such a way as to produce the total die-field pattern. The other die fields are split into sub-fields in a like manner as the first sub-field D1. In FIG. 2 (including FIG. 2a), the reference symbol D is used for the die fields, with D1 referring to the first die field, D2 the second die field, and so on. Likewise, the reference symbol S is used for the sub-fields, i.e. S1, S2, etc.

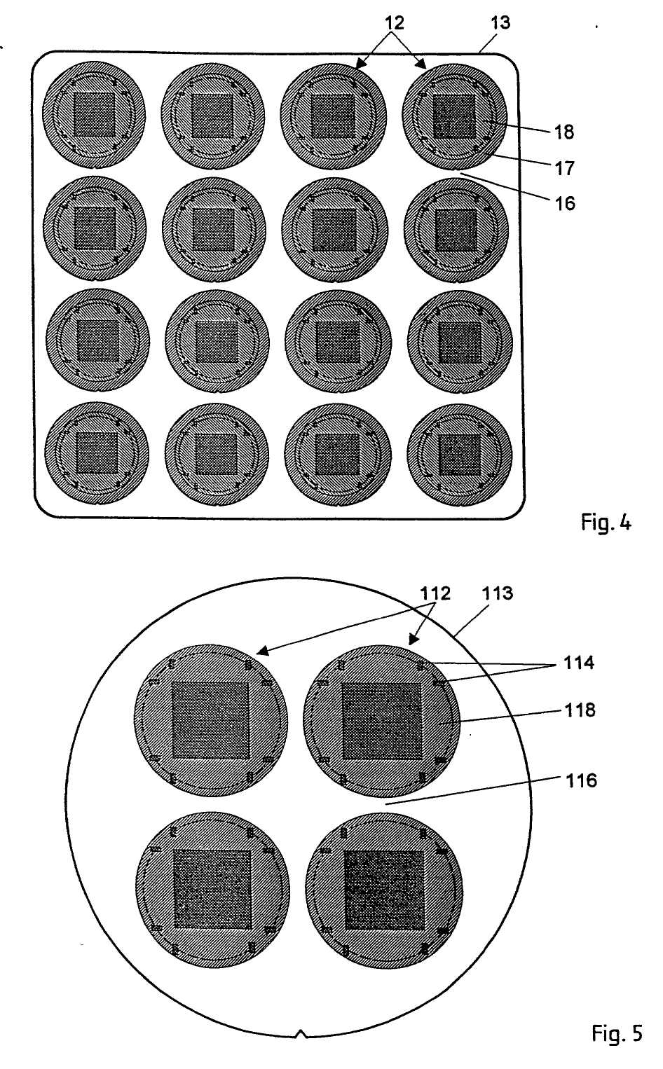

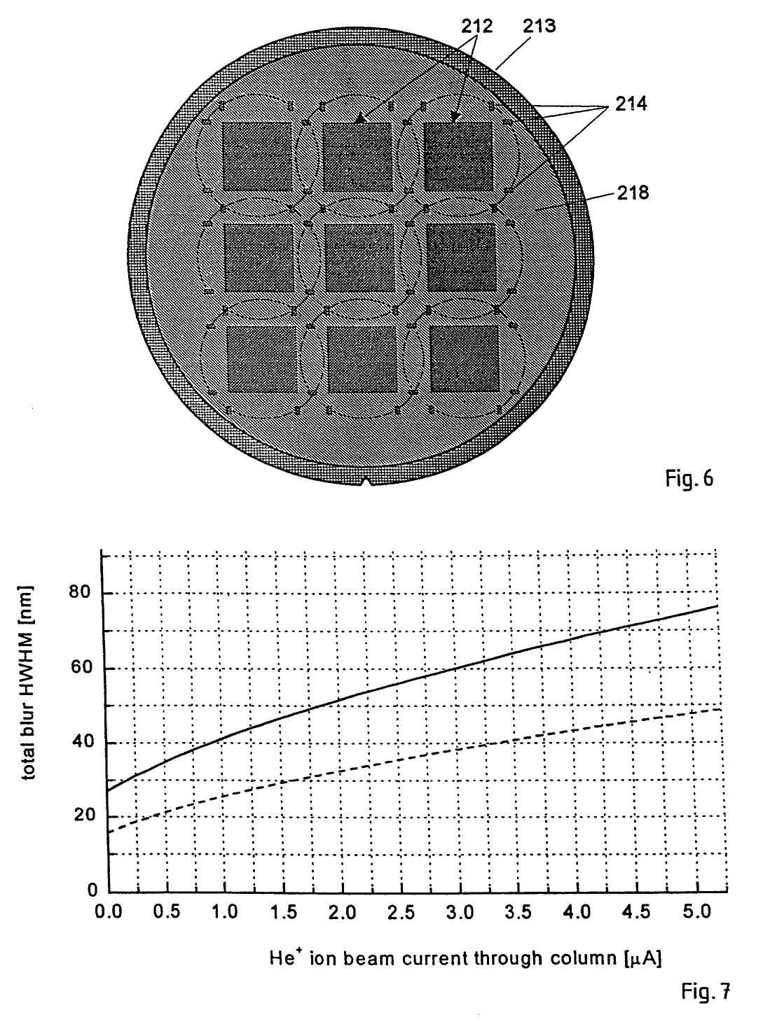

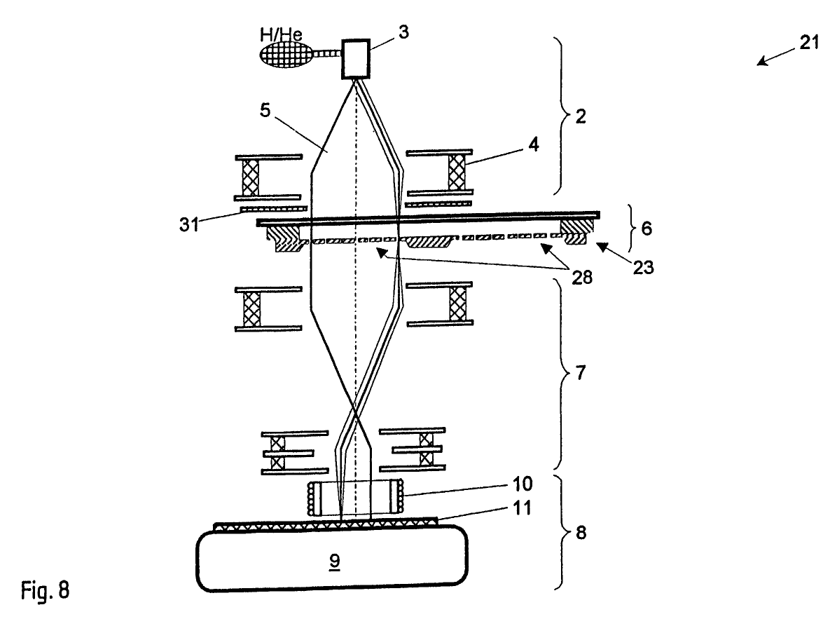

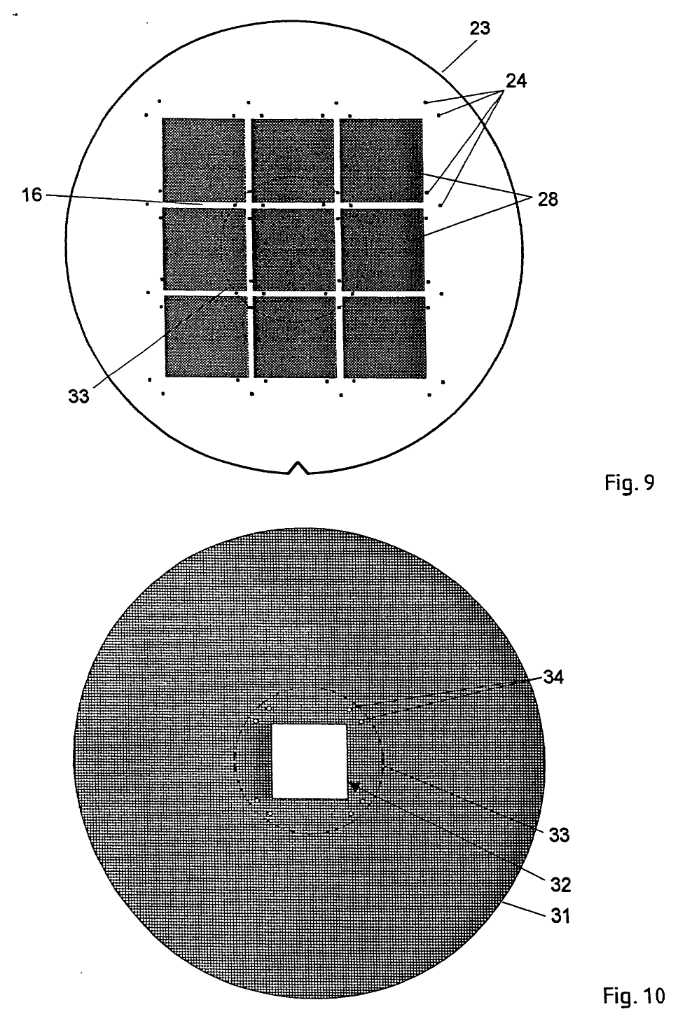

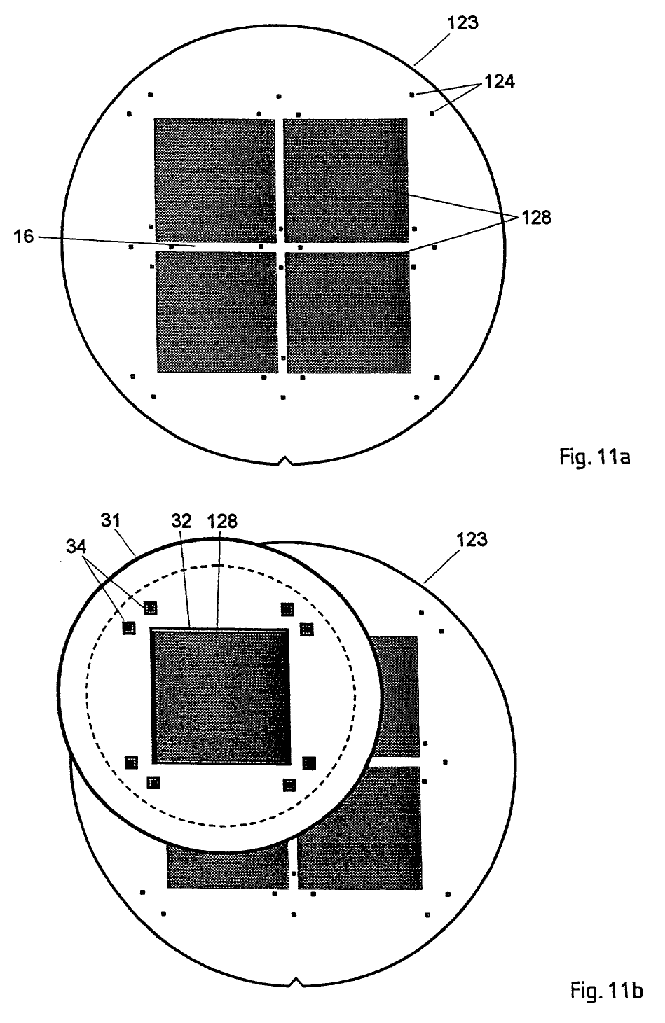

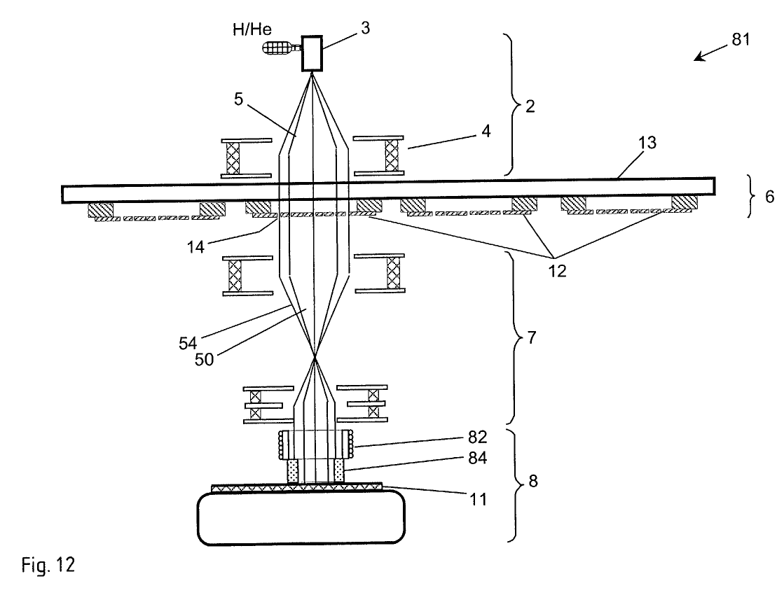

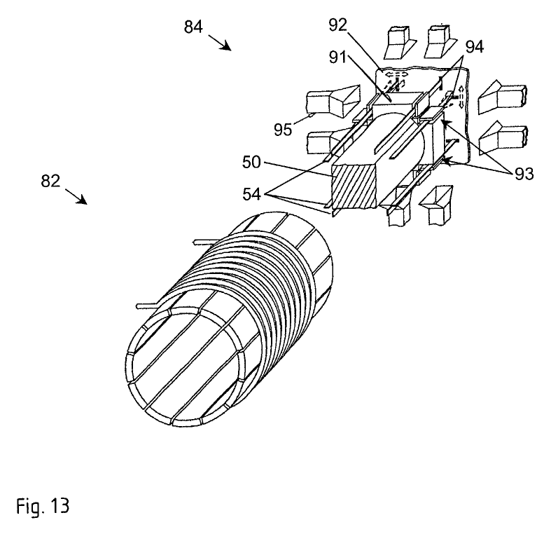

The pattern for each sub-field structure is projected by means of an individual mask 12. Since in general the sub-field structures are different from each other, a plurality of masks are needed for imaging an entire die field D of the wafer 11, in this case eight masks. According to the invention these masks 12 are arranged on a mask carrier 13. One preferred embodiment of a mask carrier according to the invention is shown in FIG. 3. The mask carrier 13 is made of a plate of glass or metal having a plurality of openings of appropriate size, which are covered each by one of the masks 12. The size of each opening is determined by the reference marks 14 arranged at the periphery of the mask design field 15 proper. The reference marks are used for the pattern lock discussed below. Due to this layout, the mask carrier 13 comprises ledges 16 surrounding the mask openings to support the masks 12. The thickness of the mask carrier 13 is for instance several mm, high enough as to sustain mechanical stress and ion irradiation without relevant effect on its shape for a high number of life-time cycles of the individual masks. In the drawings, membrane areas are shown with a cross-hatched filling.

FIG. 4 shows a mask carrier 13 on which up to sixteen masks 12 can be mounted. The numbers of masks can take any value. Numbers most suitable to be used are four, six, eight, and their multiples. It is obvious that by choosing an appropriate arrangement on a mask carrier 13, any number of masks 12 on a carrier can be realized.

The periphery 17 of the masks is used for connecting the masks 12 to the mask carrier 13. Advantageously the connection of the masks to the carrier 13 is such that each mask 12 can be individually removed again without affecting the mask carrier 13 itself or the other masks mounted on the carrier. This is possible e.g. by means of a frame to which a mask wafer is bonded, and reversibly mounting the individual wafer frames to the carrier using adjustable mounting means. If during the operation of the lithography system one of the masks 12 becomes damaged, for instance due to accumulated irradiation damage, this one mask can be removed and replaced by another mask with the same sub-field pattern, while the other masks stay on the carrier 13; the operation continues with the set of masks thus partially replaced.

A further advantage of using a composed carrier is that the sub-field masks can be produced individually. The masks are checked like usually done for stencil masks before they are mounted onto the carrier. If a defect is discovered in a mask, only this one sub-field mask has to be replaced, rather than one entire mask of a full-field design. This facilitates maintenance of the mask assembly. Moreover, since the information contained in one sub-field is only a fraction of the full field, the reduced complexity helps in lowering the probability that a defect occurs. Thus in the production process of the masks, the invention contributes to improve control of defects.

The size of one mask 12 is determined by the size of the sub-field to be imaged on the substrate. In the system of FIG. 1, a demagnification of 4υ is used, which means that the design field 15 is four times the size of the sub-fields S, i.e. a square of 50υ50 mm². This is surrounded by the ring of reference marks 14, for instance having a diameter of 108 mm, and the periphery 17 used to fix the mask. Thus the size of the mask carrier 13 of FIG. 3 will be 320υ640 mm² approximately, with eight circular openings of about 110 mm diameter. The ledges 16 separating the masks 12 have widths of the order of 10 mm.

In a variant of the layout of sub-fields, the areas of the sub-fields S may have a small overlap with each other if required to ensure contiguity of the pattern. This overlap is defined in terms of a fraction of the typical length of the structures in the overlapping region and in this case can be up to approximately 50 nm on the substrate. The overlap may vary between different sub-fields between no overlap (adjacent fields) and a maximal overlap.

The die fields D and sub-fields S in FIG. 2 are of the same size respectively. In another variant, the sizes of the fields may differ from each other, depending on the requirements of the structure to be formed, for instance with respect to the imaging quality. Then also the mask fields 15 are of different areas. Also the shape of the sub-fields can vary from quadratic to rectangular or other.

The mask carrier 13 according to the invention allows for the straightforward implementation of complementary wafer patterns. For example, the 2υ4 mask carrier 13 of FIG. 3 could be used with 4 pairs of masks, each pair providing a set of complementary patterns for one sub-field, the four sub-fields making up one die field; of course, the die field is divided into four sub-fields in this variant. On the other hand, for the die field D and sub-field S layout of the wafer 11 shown in FIG. 2, one could use two mask carriers 13 of the type as shown in FIG. 3 in order to provide for the 16 pattern masks necessary. In order to keep the error of overlaying the complementary patterns low, all patterns of each sub-field should then be placed on the same carrier. Another possibility, of course, is to use a single mask carrier with a 4υ4 array of masks as shown in FIG. 4.

The masks 12 of the mask carrier 13 shown in FIG. 3 are advantageously produced from wafers using the methods to form stencil masks well-known in the art, disclosed e.g. in the U.S. Pat. No. 5,672,449 (DE 195 27 314 A1) and references cited therein. Each mask 12 is formed as a separate mask wafer with one membrane area 18. Each membrane area 18 has a thickness substantially smaller than the wafer, and is structured with the aperture patterns used for imaging the structure of the corresponding sub-field (or complementary sub-field), comprising the mask design field 15 as well as the reference marks 14. The periphery 17 surrounding the membrane area 18 is substantially thicker and can be used for fixing the mask 12 to the mask carrier 13.

In a variant to the above embodiment, a mask carrier 113 as shown in FIG. 5 may be made from a single wafer. The aperture patterns corresponding to the different masks 112 to be imaged onto the substrate (i.e. the sub-fields or complementary sub-fields) are patterned into the wafer onto separate membrane areas 118 which also include the reference marks 114. These membrane areas have a thickness substantially smaller than the wafer material of the ledges 16 separating them.

In a second variant shown in FIG. 6, the mask carrier 213 is made from a single wafer as well, however, with one large membrane area 218 of a thickness substantially smaller than the wafer. The aperture patterns corresponding to the different masks to be imaged onto the substrate are structured in this membrane area next to each other. In this arrangement, it is also possible that the rings of reference marks 214 are overlapping so as to achieve a greater number of sub-field masks 212 on one carrier 213.

It should be noted that the invention allows for the use of a number of mask carriers 13, 113, 213 to be used in one lithography system in order to provide the number of sub-field masks required. Furthermore, the embodiments of carriers presented above may be combined with each other. For instance, a carrier with 16 masks can also be formed by composing a carrier frame 13 of the type as shown in FIGS. 3 and 4, though with four openings, and over each of the openings a wafer mask carrier 113 with four sub-field mask is mounted.

Of course, the 50υ50 mm² mask field is only one example among the various geometries imaginable. The die field D can be partitioned in various manners, depending on its size and geometry as well as desired resolution.

For 100 nm resolution lithography, for instance, a die field D of 25υ40 mm² is recommended by the SEMATECH organization. This field can conveniently be divided into six sub-fields S of 12.5υ13.3 mm². For 70 nm lithography, however, a die field D of 25υ44 mm is demanded. This corresponds, e.g., to six sub-fields of 12.5υ14.7 mm², having a diagonal of 19.3 mm. In a projector with 4υ reduction, this would result in a mask diagonal of 77.2 mm. Currently, stencil masks with mask foils of 120 mm diameter are produced starting from 6″(150 mm) wafers. The marks 14 for the pattern lock system are placed e.g. on a circle of diameter 108 mm, and the mask design field 15 can have a quadratic shape of 60υ60 mm², or a rectangular shape of 84.85 mm diameter, at most. This justifies to partition the die field for the 70 nm lithography into six sub-fields as proposed above. However, in a few years 50 nm resolution on die fields of 25υ50 or 25υ52 mm² size will have to be realized. In this case, it will be necessary to employ eight sub-fields as in the embodiment of FIG. 1. Thus the invention allows for operating the same lithography projector for multiple “generations” of lithography systems, i.e. for increasing sizes and resolutions of die fields.

In the lithography procedure of producing the total structure pattern on the wafer 11, advantageously one mask 12 is used at a time to project its pattern onto the substrate. Again referring to FIG. 2, after the pattern of one sub-field has been imaged to the first die field D1 of the wafer, the wafer stage 9 steps to the second die field D2 of the wafer and the same sub-field pattern is imaged to the second die field D2; then the third die field D3 is exposed and so on for all 42 die fields D. When all die fields have been imaged with the pattern of the first sub-field S1, the mask assembly 6 changes over from the mask of the first sub-field pattern to the mask of the second. At the same time the wafer stage 9 positions back to the first die field D1, though to the second sub-field S2 of the die field. Now the sub-field pattern of the second mask is imaged consecutively to all die fields D in a likewise manner to the first sub-field. This is repeated for all remaining sub-fields S.

Now referring to a further preferred embodiment 81 of the invention shown in FIG. 12, advantageously a pattern lock system 84 is provided in connection with the target station 8. The pattern lock serves to align the position of the pattern image with the substrate. Reference beamlets 54 are produced by the reference marks 14 in the mask 12; they are not projected onto the substrate 11, but into the pattern lock system 84 of the target station 8. The pattern lock system 84 detects the position of the beamlets, calculates the deviation from the desired position with respect to the sub-field to be imaged and derives correction signals for adjusting the position of the pattern image. The pattern lock system 84 of this embodiment is shown in FIG. 13 in greater detail. A scanner block 91 surrounds the die beam 50 which projects the image onto the substrate. The reference beamlets 54 are projected into channels 93 of the scanner block. The channels 93 are provided with electrostatic deflection plates which sweep the reference beams 54 across reference marks 94 situated on a reference plate 92. The reference marks are, e.g., realized as trapezoidal grooves. This sweep is indicated in FIG. 13 by dashed arrows. The positions of the reference plate 92 and the scanner block 91 are determined and held constant during the die exposure by a commercial optical alignment system, not shown in the figures. As the ions hit the surface of the reference plate, secondary electrons are emitted and detected by detectors 95. Suitable detectors are, e.g., channeltrons or secondary electron multipliers. The amplitude of the secondary electron current depends on the position of the beamlet, i.e., coinciding with, or outside of the groove. The secondary electron current is measured versus the deflection voltage, and from the shape of the curves thus measured the position of the reference beams 54 in the non-deflected state is derived. This result is compared electronically to the required beamlet position to place the image of the die beam 50 at the required position on the substrate 11 (not shown in FIG. 13), and respective alignment signals are derived to adjust the alignment of the image on the wafer. The alignment adjustment may be performed by controlling the fine positioning of the substrate or advantageously by appropriately adjusting the optical properties of the optical column. In the embodiment shown in FIGS. 12 and 13, a correction element 82 is provided in front of the wafer 11 and the pattern lock system 84. The correction element 82 comprises an electrostatic multipole, to shift and/or correct the shape of the image, which is surrounded by a solenoid, to rotate the image.

In the U.S. Pat. No. 4,967,088 further details of a pattern lock system are disclosed, which is herewith included by reference. In this context, it should be noted that it is of no relevance to the discussion in this place whether the mask is positioned well apart from the substrate (as in the embodiment shown here) or directly in front of the substrate as in the embodiment of the U.S. Pat. No. 5,742,062.

The pattern lock system 84 serves as an alignment system to achieve the fine adjustment of the substrate positioning with respect to the projected ion beam. Thus it allows for the wafer stage 9 to position the sub-field S, to which the pattern image shall be projected, only within the range of the pattern lock system 84. The final adjustment is then made electronically by means of the ion optical system, rather than by the wafer stage 9 itself, offering the well-known advantages of high accuracy and speed. Of course, in order that this is possible the mask assembly 6 is required to position the mask 12 within a certain spatial and angular accuracy, for instance ρ1 μm and ρ50 μrad (about ρ0.17 arc minutes). This can easily be provided for by means of positioning means similar to those used for wafer stages well-known to those skilled in the art. The mask assembly 6 of the preferred embodiment is allotted the time of 1 s to perform the mask movement and positioning, and thus the mask needs to withstand an acceleration well below 0.1 g (1 g|10 m/s²).

One immediate consequence of the use of a number of masks instead of one single mask is that the width of the exposure area on the substrate is smaller since the exposure area is reduced from that of a die field to that of a single sub-field. As a consequence, the dimensions of the ion optical system including the width of the beam at the mask and the length of the optical column can be reduced accordingly. The factor K involved in this resealing is the quotient of the diameters of the exposure areas, which in this case is 3.17.

The reduction of the size of the ion projection system is one major advantage of the invention. As becomes clear from the documents mentioned above, e.g. the U.S. Pat. No. 4,985,634 and 5,742,062, the apparatus of a full-field projector for a 25υ50 mm² die-field takes considerable space; a common value of the distance of the ion source to the wafer is about 6 m. This considerable size often gives rise to problems upon implementation in a production line. The invention allows to scale down the optical system by the factor K. Thus the source-wafer-distance reduces to about a third, namely about 2 m. The lateral dimensions scale accordingly. Moreover, the mass of the system is drastically reduced since it varies with the cube of the scaling factor, K³|30. Even if not all components will follow this reduction in size—for instance the pattern lock system and the ion source cannot shrink too much any more—the parts which mainly determine the overall size are the components of the ion-optical system whose (linear) dimensions scale strictly with the factor K. Thus the resulting apparatus according to the invention not only can be fit into a given space far more comfortably but is overall much more easy to deal with.

As another consequence to the reduced area of mask to be illuminated, the aberration effects of the ion optical system are reduced by a factor K as well. Thus a reduction in size advantageously improves the image quality by reduction of distortion and blur.

For ion projector systems with an optical column between mask and wafer, a further advantage is the gain in resolution that comes about from the reduced size of the optical system, as is discussed below.

If a certain ion projector design is reduced in all dimensions by a factor of K, this results in the following changes under the (preliminary) condition that the reduced design is operated at the same voltages at the lens electrodes and with the same total ion-beam current through the optical column. The area of the exposure field is reduced by a factor of K², thus exposure of K² sub-fields is needed for the full die field area. The current density in the sub-field is increased by K². Thus, the exposure time per sub-field, as determined by the total ion dose applied to an area unit of photo-resist, is reduced by K². Therefore, the total exposure time remains constant.

As mentioned above, the geometric (due to finite numerical aperture) and chromatic (due to energy spread of the ions emitted from the ion source) blurs are reduced approximately by the reduction factor K. The stochastic blur, which is due to Coulomb interactions of the ions mainly in the region of the beam crossover, is reduced by a factor K^{0.8} The latter result arises as the stochastic blur is approximately proportional to F₂/r_{c}^{0.2}, where F₂ is the focal length of the objective lens scaling with 1/K, and r_{c} is the radius of the crossover also scaling with 1/K. Since the geometric and chromatic aberrations on one hand and the stochastic blur on the other hand are of comparable size, the total blur is improved by a factor of K^{0.9}, approximately. The resolution is a fixed multiple of the total blur, e.g. 2.25 times the total blur, and is therefore improved by a factor of K^{0.9}, approximately, while the exposure time stays unchanged.

Therefore, for a reduction from 22 mm down to 12.5 mm, the reduction factor is K=22/12.5 =1.75, from which the improvement in resolution derives from the above argument as 1.66.

To illustrate this result, FIG. 7 shows the relation between the ion-beam current which is projected through the ion-optical column and the total blur, defined here as the half-width of half-maximum of the image of a point. The curves are graphical representations of this relation calculated for the ion projection system as shown in FIG. 1; values in FIG. 7 are stated in μA and nm, respectively, for this system. The relation can, though, easily be applied to other lithography systems by scaling with scaling factors near unity; the units should then be interpreted as arbitrary units. Two curves are shown, of which the upper one depicts the current-blur-relation as determined for an exposure field of 22 mm side length of the full-field projector. The lower, dashed curve gives the current-blur-relation of an exposure field of 12.5 mm according to the invention. As clearly visible, this curve is well below the other, demonstrating the gain in resolution for fixed beam current achieved by exposure field reduction.

In order to carry out an estimation of the total wafer throughput for this set-up, the graphs of FIG. 7 are, as a first step, re-interpreted such that by reducing the exposure field, it is possible to raise the beam current through the optical column while keeping constant the resolution on the substrate. Here, a feature size of 100 nm which defines the resolution desired shall be assumed, from which follows the allowed blur of 45 nm. This latter value corresponds to the horizontal line in FIG. 4, which intersects the two curves of the current-blur-relation at two points. These two points at about 1.3 μA and 4.25 μA, respectively, mark an increase of the ion-beam current by a factor of more than three. The increment in beam current, in turn, reduces the exposure time by the same factor.

Estimating the exposure time, a typical value of 25% is taken for the pattern coverage (denoting the pattern area relative to the total exposure area of the substrate), as well as a sensitivity of 1 μC/cm² for the photo-resist. With these values one arrives at a required ion-beam current density of 4.25 μA/(0.25υ (1.25 cm)²) −10.9 μA/cm², and therefrom an exposure time of 1μC/cm²/10.9 μA/cm²=0.092 s for each sub-field. This result is now used for determining the processing time for one wafer as specified in Table 1.

The time needed for one wafer comprises the following contributions as listed in Table 1:

a) the wafer overhead. This is the time to unload, load and position the wafer 11 onto the target station 8; a typical value consistent with the state of the art is 20 s.

b) exposure of the sub-fields. For every die field D each sub-field S is exposed, making a total of 42υ8 exposures.

c) stepping the die field in the x-direction, i.e. along one “line” of die fields D. For positioning by one step of [symbol] x=25 mm, a time of [symbol] t=2 [symbol] ( [symbol] x/a)=0.07 s is needed, assuming a wafer stage 9 with a maximal acceleration of a=2g and neglecting the acceleration overheads. All but the first die field of each “line” is positioned by x-direction stepping, thus there are 37 events for each sub-field.

d) stepping to the next “line”. The initial die field of every line but the first is positioned. In a like manner to the previous point, this contribution amounts to 4 events of 0.10 s, approximately, for each sub-field.

e) changing the mask field in the mask wafer 13. For this a time of 1 s, using an acceleration well below 0.1 g, is sufficient in order to move in and establish proper positioning of the next wafer. During this time the wafer stage 9 has sufficient time to re-step to the first die field D1. Only seven events are counted here, since the very first mask change can be done during the wafer change of point a).

TABLE 1
Times for lithography processing of one wafer

| | | | |
|---|---|---|---|
| wafer overhead | | | 20 s |
| sub-field exposures | 42 ν 8 ν | 0.092 s | 30.9 s |
| stepping in x-direction | 37 ν 8 ν | 0.07 s | 20.7 s |
| stepping in x-y-direction | 4 ν 8 ν | 0.10 s | 3.5 s |
| change of sub-field mask | 7 ν | 1 s | 7 s |
| total | | | 81.8 s |

The total sum of these times amounts to 81.8 seconds resulting in a 300mm wafer throughput of 44 wafers per hour. This demonstrates that the main impact of the eight-fold repetition of exposures is largely compensated by the reduced exposure time resulting from the enhanced resolution relation according to the invention.

In the case that complementary patterns are used, a procedure analogous to that of Table 1 can be applied. For instance, if starting from the above example each sub-field pattern is split into two complementary patterns, the resulting 16 masks can be arranged on one mask carrier similar to that of FIG. 2. The corresponding estimation of the wafer throughput is given in Table 2, where the meaning of the items is strictly analogous to that of FIG. 1. In this case the wafer processing time of 145.2 seconds corresponds to a throughput of 24.7 wafers per hour.

However, the fact should not be overlooked that the embodiment of the invention including the time schedule of the Tables given above poses high demands on the wafer stage 9 which must be able, on one hand, to reach accelerations sufficiently high and, on the other hand, to provide sufficient positioning accuracy for the substrate. In this context, though, it is worth to note that the use of a pattern lock system 10 is a very efficient means to relax the needs

TABLE 2
Times for processing of one wafer, using split patterns

| | | | |
|---|---|---|---|
| wafer overhead | | | 20 s |
| sub-field exposures | 42 ν 16 ν | 0.092 s | 61.8 s |
| stepping in x-direction | 37 ν 16 ν | 0.07 s | 41.4 s |
| stepping in x-y-direction | 4 ν 16 ν | 0.11 s | 7.0 s |
| change of sub-field mask | 15 ν | 1 s | 15 s |
| total | | | 145.2 s |

with respect to quick end positioning of the wafer since the wafer stage 9 needs only to position into the range of the pattern lock system 10.

The above estimates, yielding throughputs of about 44 or 25 wafers per hour, demonstrate that the lithography system according to the invention is able to yield a wafer throughput viable for the semiconductor production. Although the nominal throughput is lower in comparison with that of full-field systems designed earlier, this trade-off is compensated by the other advantages of the invention already discussed.

FIG. 8 shows a lithography system 21 of a second preferred embodiment according to the invention allowing for the use of mask wafers with a plurality of mask fields. In order to illuminate only one mask field of the mask wafer at a time, this lithography system 21 is provided with a screen 31 serving as a diaphragm for the mask field. In the following, only those features of the lithography system 21 shown in FIG. 8 are described which differ from the embodiment shown in FIG. 1.

The ion beam 5 is projected through an aperture 32 in a screen 31 (FIG. 10) onto a stencil mask field 28 carried on a mask wafer 23 (FIG. 9). According to the invention, the mask wafer 23 comprises a plurality of mask fields 28. Each of the mask fields 28 is formed by a membrane with a design area having apertures for producing a beam pattern, which in turn serves to form a structure pattern on the substrate. During exposure of one mask field 18, all the other mask fields carried by the mask wafer are shielded by the screen 31. Small portions of the ion beam 5 travel through the reference mark apertures 34 in the screen 31 to be projected onto the respective pattern lock membranes 24 on the mask wafer 13. Here, the reference beamlets referring to the design apertures being imaged, are produced. All other pattern lock membranes in the mask wafer are shielded by the screen 31.

The beam pattern produced by the mask field 28 is then projected by the optical column 4 onto the substrate 11 as described in the context of FIG. 1.

A mask wafer 23 for the use in this embodiment of the invention is shown in FIG. 9. The mask wafer 23 is made of silicon, with the mask field membranes 28 etched to considerably smaller thickness than the surrounding wafer material. The size of each membrane is determined by the pattern design field 15 and is only slightly larger (e.g. by 10%) than the design field. Each membrane is surrounded by the wafer material of original thickness. The mask field membranes are arranged in a regular manner with only small stripes of wafer material between each other. The reference marks, which are used for the pattern lock 10 discussed below, are carried on separate small membranes, preferably of the same thickness as the mask field membranes. Preferably, the reference marks are situated on circles centered to the pattern design field to which they refer. In such a layout, the pattern lock membranes are partly situated on the thin stripes of wafer material arranged between the mask membranes, as can be seen from FIG. 9. Due to this layout, a mask wafer 23 of 300 mm diameter may carry 9 mask membranes of 55×55mm² size together with the respective pattern lock membranes.

As for the lithography system 1 of FIG. 1, also in this embodiment the pattern lock system 10 allows for the wafer stage 9 to position the sub-field S, to which the pattern image shall be projected, only within the range of the pattern lock system 10. As explained above, the mask needs to withstand only an acceleration well below 0.1 g.

The mask fields 28 of the mask wafer 23 shown in FIG. 9 are advantageously produced using the methods to form stencil masks well-known in the art, disclosed e.g. in the DE 195 27 314 A1 (U.S. Pat. No. 5,672,449) and references cited therein.

FIG. 11 shows a variant of the invention relating to the ion beam illumination principles of a 200 mm mask wafer. FIG. 11a shows the layout of the mask wafer 123 itself having four subfields 128, whereas in FIG. 11b the screen 31 serving as aperture plate is shown in conjunction with the mask wafer 123. The dashed circle 33 represents the area irradiated by the ion beam 5. The fixed aperture plate 31 provides that only one specific mask subfield is illuminated, together with the corresponding eight small membrane fields 24 with pattern lock openings structures. Aperture plate and stencil mask are at the same temperature (room temperature) and have the same thermal emissivity. The ion beam tends to heat up the aperture and the stencil mask areas which are illuminated by the ion beam. Cooled lens electrodes tend to cool down the area which can radiate to the cooled elements. By proper combination there is virtually no change of temperature of the portions of the screen 31 and the stencil mask which are exposed to the ion-beam. In addition there is thermal radiation added to the homogenous ion beam. Thus, an excellent performance can be ensured. If the ion beam is turned off, there is the possibility to increase the intensity of the thermal radiation so that even under these conditions the mask temperature remains constant. This will enable the change of stencil mask subfields within 1 sec and the change of complementary stencil masks within 5 sec.

It should be noted that the struts 16 between the membrane fields do not have to be perpendicular as shown in the figures. These struts can be wet-chemically etched as part of the SOI stencil mask wafer flow fabrication process. No additional fabrication steps with respect to the known fabrication sequence are required.

Of course, the 55υ55 mm² mask field (for a 50υ50 mm² design field) is only one example among the various geometries imaginable. The die field D can be partitioned in various manners, depending on its size and geometry as well as desired resolution.

An estimation of the total wafer throughput for the lithography system 21 shown in FIG. 8 for feature sizes of 100 nm to be resolved, chip sizes of 25υ50 mm² and imaged subfields of a size 12.5υ12.5 mm² leads to the same results as stated above in Table 1.

In the case that complementary patterns are used, a procedure analogous to that of Table 1 can be applied. For instance, if starting from the above example each sub-field pattern is split into two complementary patterns, the resulting 16 masks can be arranged on two mask wafers similar to that of FIG. 9. The time for the exposure of a mask is taken from Table 1, where the wafer overhead time is excluded; therefore, the exposure time is 81.8 s -20 s=61.8 s. The corresponding estimation of the wafer throughput is given in Table 3. In this case the wafer processing time of 148.6 seconds corresponds to a throughput of 24.7 wafers per hour.

TABLE 3
Times for processing of one wafer, using split patterns

| | |
|---|---|
| wafer overhead | 20 s |
| exposure of mask 1 | 61.8 s |
| mask change | 5 s |
| exposure of mask 2 | 61.8 s |
| total | 148.6 s |

The above estimates, yielding throughputs of about 44 or 24 wafers per hour for feature sizes of 100 nm, demonstrate that the lithography system according to the invention is able to yield a wafer throughput viable for the semiconductor production.

It will be recognized that the present invention is not limited to the specific forms described above; rather, it is understood that other embodiments can be realized by those skilled in the art without departing from the spirit and scope of the invention. For instance, the invention can be applied equally well to projection lithography systems, wherein the mask is placed immediately in front of the wafer.

We claim:

1. A particle beam lithography system for imaging a structure pattern onto one or more fields on a substrate comprising
a particle-optical system with an illumination system to provide a substantially homocentric or telecentric beam of electrically charged particles,
a mask assembly arranged to position masks in the path of the particle beam, each of the masks having a membrane with apertures for producing a desired beam pattern which is imaged onto the substrate, and
a target station after the mask for supporting and positioning the substrate,
wherein the mask assembly comprises at least one mask carrier with a plurality of masks having different aperture patterns corresponding to structure patterns to be imaged onto respective areas of the substrate, at least two of the structure pattern areas being different, the mask assembly being arranged to project different aperture patterns at different times onto the substrate,
and wherein each mask is provided with reference marks producing reference beamlets, the target station comprises an alignment system to measure the position of the reference beamlets and, from the measurement, to determine alignment control signals for aligning the position of the image of the aperture pattern with a desired position on the substrate.

2. The lithography system according to claim 1, wherein
the charged particles are ions, preferably hydrogen or helium ions.

3. The lithography system according to claims 1, wherein
the imaged patterns of the masks, as a whole, combine together to form the total pattern of a die-field of the substrate.

4. The lithography system according to claim 1, wherein
the patterns of the masks are to be imaged onto adjacent areas of the substrate.

5. The lithography system according to claim 1, wherein
the patterns of the masks are to be imaged onto partially overlapping areas of the substrate.

6. The lithography system according to claim 1, wherein
the alignment system is connected to the particle-optical system, the particle-optical system being adjustable with respect to its projection properties by means of the alignment control signals.

7. The lithography system according to claim 1, wherein
the mask carrier is a mask wafer in which the masks are formed as mask fields structured with aperture patterns to be imaged onto the substrate.

8. The lithography system according to claim 7, wherein
the mask wafer is provided with separate membrane areas, each membrane area having a membrane of substantially smaller thickness than the wafer, and the membranes are structured with the corresponding mask field aperture patterns and the respective reference marks.

9. The lithography system according to claim 1, wherein
eight reference marks are provided for each mask.

10. The lithography system according to claim 7, wherein
the mask wafer is provided with one membrane area having a membrane of substantially smaller thickness than the wafer and the membrane is structured with the different mask field aperture patterns and reference marks.

11. The lithography system according to claim 10, wherein
the areas surrounded by the respective reference marks of the masks are overlapping on the mask membrane.

12. The lithography system according to claim 1, wherein
each mask on the mask carrier is formed as a separate wafer with a membrane area of substantially smaller thickness than the wafer, the membrane being structured with the corresponding aperture pattern.

13. The lithography system according to claim 12, wherein
the masks are mounted to the mask carrier and are individually replaceable.

14. The lithography system according to claim 13, wherein
the masks are mounted to the mask carrier by adjustable mounting means.

15. The lithography system according to claim 1, wherein
the particle-optical system comprises an optical column arranged between mask assembly and substrate to project the patterned beam onto the substrate to form an image of the mask apertures.

16. A lithographic method for imaging a structure pattern onto one or more fields on a substrate, in which a substantially homocentric or telecentric beam of electrically charged particles is generated in an illumination system and shaped into a desired beam pattern by means of a mask positioned in the path of the particle beam and having a membrane with apertures for producing the beam pattern, which in turn is projected onto the substrate supported and positioned by a target station to form an image of the mask apertures,
wherein a plurality of aperture patterns defined by respective masks positioned on at least one mask carrier are used for producing structure patterns to be imaged onto respective areas of the substrate, at least two of the structure pattern areas being different,
different aperture patterns being projected at different times onto the substrate,
and wherein reference beamlets are produced by means of reference marks provided for each mask, and, from measurement of the position of the beamlets, alignment control signals are determined for aligning the position of the image of the aperture pattern with a desired position on the substrate.

17. The method according to claim 16, wherein
for each pattern, the corresponding structure pattern is projected subsequently onto every area of the substrate which is to be imaged with this pattern, positioning the substrate for each of these areas, before switching to the next pattern to be used by moving the mask carrier in a position where the mask corresponding to the next pattern is illuminated by the beam.

18. The method according to claim 16, wherein
ions, preferably hydrogen or helium ions, are used.

19. The method according to any one of claim 16, wherein
the structure patterns, as a whole, combine together to form the total pattern of a die-field of the substrate.

20. The method according to any one of claim 16, wherein
the patterns are imaged onto adjacent areas of the substrate.

21. The method according to any one of claim 16, wherein
the patterns are imaged onto partially overlapping areas of the substrate.

22. The method according to claim 21, wherein
the alignment of the image position is performed by adjusting the projection properties of the particle-optical system by means of the alignment control signals.
